(19) United States
(12) Patent Application Publication
(10) Pub. No.: US 2015/0099498 A1
(43) Pub. Date: Apr. 9, 2015

(54) Multimedia Based Caller Identification (CID) System and Method

(71) Applicant: M800 Limited, Kowloon Bay (CN)

(72) Inventor: Peter Kwong Choi CHAN, Kowloon Bay (CN)

(73) Assignee: M800 LIMITED, Kowloon Bay (CN)

(21) Appl. No.: 14/510,841

(22) Filed: Oct. 9, 2014

Related U.S. Application Data
(60) Provisional application No. 61/888,573, filed on Oct. 9, 2013.

(51) Int. Cl. H04M 3/42; H04W 4/16

(52) U.S. Cl. CPC H04M 3/42051; H04W 4/16
USPC 455/416

(57) ABSTRACT

A system, application platform, and method that helps a recipient receiving a phone call identify a caller in advance of answering the incoming call. According to the invention, a caller is able to create a multimedia content using a software application platform present in the mobile device, upload the created multimedia content in a cloud storage space, thereafter, when the caller places a call to any recipient, the multimedia content automatically streams from the cloud storage space into the recipient's mobile device in a display loop until the recipient responds to the incoming call and during the subsequent conversation helping the recipient identify the caller.

### FIELD OF THE INVENTION

The present disclosure is generally related to caller identification process, and more particularly to an application platform and method that displays multimedia contents as caller identification at the recipient's computing device at the time of incoming call and during the subsequent conversation.

### BACKGROUND OF THE INVENTION

Generally, the mobile phone owners group phone numbers stored in their mobile phone according to family, friends or the like, and manually designate a ring tone to indicate each group or manually designate a ring tone to indicate each contact person.

When their mobile phone receives an incoming call from a caller, the ring tone designated for the caller rings, and thus the mobile phone owner may identify the caller of the incoming call. Such approach of identifying the caller is cumbersome and practically it is not possible for the mobile phone owners to manually designate a ring tone for each person and identify the caller based on the set ring tone.

In previous communication systems, normally when the recipients receive a phone call the telephone number of the caller or a static image of the caller is usually displayed in the recipient's mobile device. This type of incoming communication notification is static and is not very informative for the recipient.

In another communication system, the caller identification involves displaying a picture corresponding to the caller upon receiving an incoming phone call from the caller.

For example, some of the mobile phones provide an option to the recipients where the recipients can pre-link picture of the caller with the phone book entry so that thereafter, the pre-linked image of the caller is displayed in the recipients mobile device upon receiving an incoming call from the caller. Such caller identification provides limited entertainment value since every time the same picture is displayed. The recipient needs to re-link new image with the phone book entry corresponding to the caller if the recipient wishes to change the image of the caller. This is time consuming and cumbersome process.

In the past multimedia caller identification systems and methods were available where multimedia related to the caller is displayed on the mobile device of the recipient being called by previously storing the multimedia content identifying the caller in the recipient's mobile device as discussed above or by retrieving the multimedia content pre-stored in the address database respectively. Such systems and methods are proven to be expensive and inefficient in terms of fulfilling the growing needs of the world where the recipients are eager to instantly know who the caller is and the purpose of the call.

Accordingly, there is a need for an application platform and method that provides a cloud based multimedia caller identification feature that addresses or at least ameliorate the short comings associated with conventionally employed systems, methods or techniques for caller identification.

### BRIEF SUMMARY OF THE INVENTION

An object of the invention is to provide an improved, easy and cost effective multimedia based caller identification process.

Another object of the invention is to provide a more satisfactory solution that replaces conventional caller identification systems discussed in aforementioned background.

Another object of the invention is to allow a caller to customize/personalize his caller identification information while placing a call.

According to the invention, a caller is able to create a multimedia content (a video of predefined length, a high resolution image, animated video, and the like) using conventionally available multimedia content editing software tools present in his/her mobile device or use an application platform of the present invention configured in the mobile device of the caller to create a desired multimedia content, upload the created multimedia content in the cloud storage space by pushing a button on the graphical user interface (GUI) display provided on activation of the application. Thereafter, when the caller places a call to any recipient, the called recipient is able to identify the caller through the multimedia content streaming from the cloud space into mobile device of the recipient identifying the caller until the recipient responds to the incoming call.

Other aspects, features, and advantages of the present invention will readily be apparent from the following detailed description, simply by illustrating embodiments and implementations, including the best mode contemplated for carrying out the present invention.

### BRIEF DESCRIPTION OF THE DRAWINGS

The present invention will become fully appreciated as the same becomes better understood when considered in conjunction with the accompanying drawings, in which like reference characters designate the same or similar parts, and wherein:

FIG. 1 is a diagram illustrating a conceptual exemplary overview of multimedia caller identification system of the present invention;

FIG. 2 is pictorial diagram illustrating an exemplary method of displaying multimedia caller identification in a mobile device of a recipient while placing a phone call by a caller

FIG. 3 is a flow schematic diagram illustrating an exemplary method of displaying multimedia caller identification in a mobile device of a recipient while placing a phone call by a caller.

### DETAILED DESCRIPTION OF THE INVENTION

Before explaining at least one embodiment of the present invention in detail, it is to be understood that the invention is not limited in its application to the details of construction or to the arrangements of elements in the following description or illustrated in the drawings. The invention is capable of other embodiments and of being practiced and carried out in various ways. Also, it is to be understood that the phraseology and terminology employed herein are for the purpose of the description and should not be regarded as limiting.

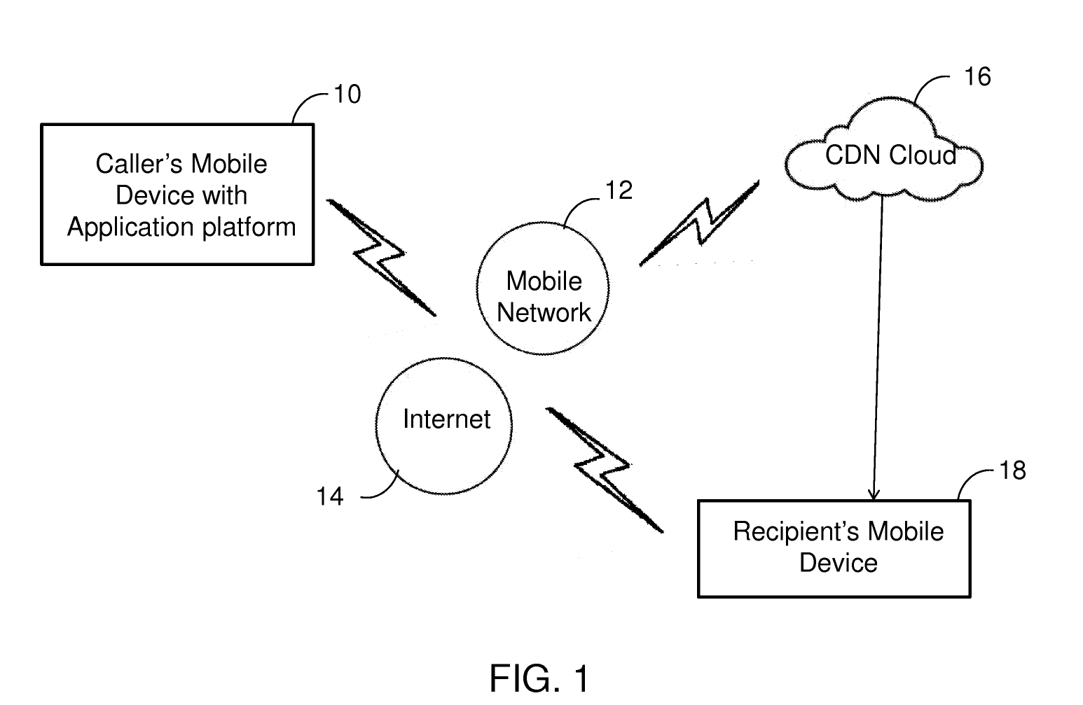

Turning now descriptively to the accompanying drawings FIGS. 1-3. FIG. 1 in particular illustrates an exemplary overview of the system according to an embodiment. As seen, the caller's mobile device 10 is configured with application software proposed by the present invention. The caller is enabled to create any multimedia content, for example video of predetermined length (limited in time), a picture/image of high resolution, animation video using the application. However, it is to be understood that creation of multimedia is not limited to the use of the application in the mobile device 10 of the caller. The caller can optionally make use of conventionally available software tools for creating such multimedia content.

Though the application software embodying the functionality of the present invention is pre-configured in the mobile device 10, it is to be understood that the application can also be accessible by the caller through a web browser as a web-based application whenever required or as web service using mobile device 10 over a communication network, preferably an Internet. It is also to be understood that the implementation of the present application platform is not limited to the use of a specific operating platform, Windows, Linux or UNIX, and the like or any programming language.

The mobile device 10 of the caller makes use of subscribed mobile communication network 12 or internet facilities 14 to communicate or exchange data with any other mobile devices 18. FIG. 1 also shows an example configuration in which cloud-based storage and retrieval is implemented in accordance with the embodiment. As depicted, the mobile device 10 of the caller is enabled with the application wherein the caller can push the multimedia content created by him/her into the cloud storage space 16. One content delivery network (CDN) cloud from a third-party such as, for example, Akamai as shown in FIG. 1 for simplicity and one skilled in the art will appreciate that there may be a different number of CDN clouds served by various operators.

As depicted, when the caller places a call for a recipient, the originating call establishes a communication path via mobile communication network/internet with the recipients mobile device 18. Before the recipient picks up and answers the incoming call and during the subsequent conversation, the uploaded multimedia content in the cloud storage space 16 streams into the recipients mobile device and keeps on playing or display in a loop until the call ends. According to the embodiment, the multimedia content is cached in the recipients mobile device to prevent the re-download of the content unless the multimedia content is not updated by the caller.

The mobile devices 10 or 18 may refer to a computing device that may be implemented as a portable (or mobile) electronic device such as a mobile phone or smart phone, or, alternatively, a personal data assistant (PDA), a personal media player device, an application specific device such as a tablet device, or a hybrid device that may include any of the above functions.

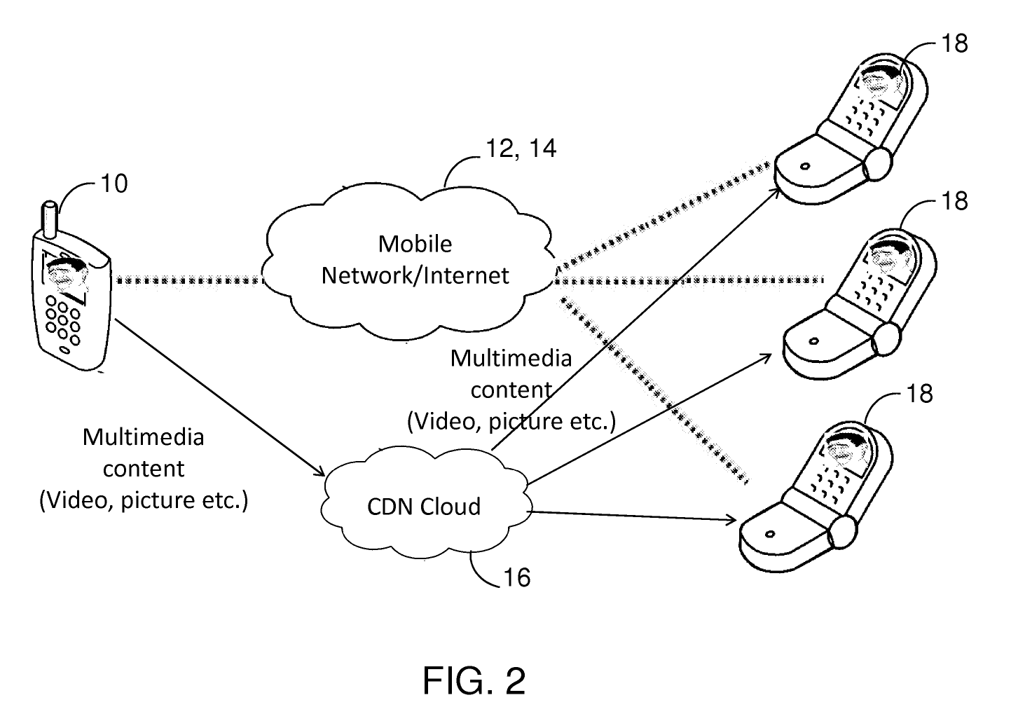

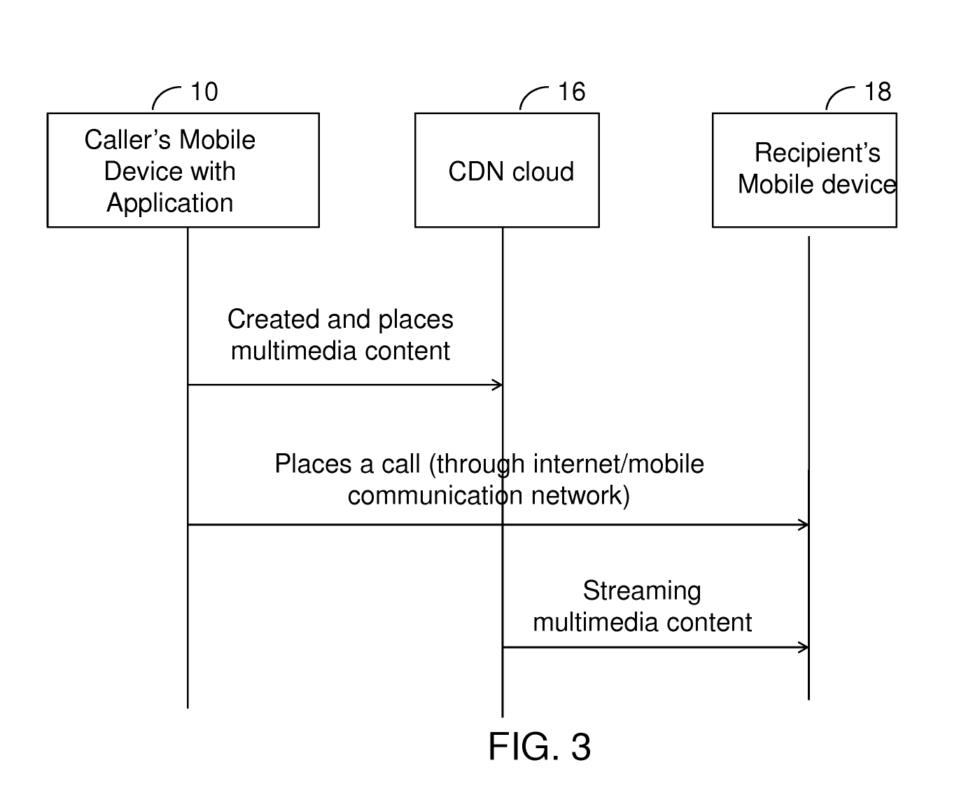

FIG. 2 and FIG. 3 in particular illustrate an exemplary method of displaying multimedia caller identification in the mobile device of the recipient while placing a phone call by a caller. As shown the caller, upon creation of multimedia content for caller identification, (for example, a photograph, image, or a video of predetermined length) places the video/multimedia content in the cloud storage space 16 using an application, such as a software application platform, (as described in FIG. 1) configured in the mobile device 10. Thereafter, when the caller places a call for an intended recipient, or optionally a group call for multiple recipients, through a subscribed mobile communication network or internet then the video/multimedia content stored in the cloud space 16 streams into the mobile devices of the recipients 18.

As will be appreciated from the foregoing description, the proposed cloud based multimedia caller identification method and system has advantageous feature that the multimedia content (for example, a photograph, image, or a video) created and stored in the cloud storage space by the caller can be customized or updated anytime whenever the caller wishes to do so. The recipient is not required to readily store the multimedia content in his/her mobile device and link the multimedia content with the caller phone address inventory. Further, the caller can convey information about the importance of the call to the recipient through the multimedia video created and uploaded as caller identification in the cloud.

While the proposed invention is highly expected for future use as a new caller identification system because of its unique properties, it has never been exploited industrially. The present invention focuses on available communication systems, development of the proposed application platform and theory behind cloud storage space and their properties which help meet the objectives and advantageous features of the invention.

Having thus described various exemplary embodiments of the invention, it will be understood by those skilled in the art that modifications or changes in details of the invention may be implemented without departing from the spirit and scope of the invention as defined in the following claims.

I claim:

1. A multimedia based caller identification method comprising:
creating visual multimedia content using a software application platform, and uploading said created multimedia content to a content delivery network (CDN) cloud storage mean, and
placing an outgoing telecommunication call to a recipient, and streaming the multimedia content to the recipient from said cloud storage means in a display loop when call recipient receives call, and
storing said multimedia content in cache of receiving telecommunication device via software application platform, and
continuing streaming the multimedia content during the call in said display loop until the call ends.
